(19) United States
(12) Patent Application Publication
(10) Pub. No.: US 2014/0250177 A1
(43) Pub. Date: Sep. 4, 2014

(54) RECOMMENDING CONTENT BASED ON PROXY-BASED PREFERENCE INDICATIONS

(71) Applicant: Google Inc., (US)

(72) Inventor: Timothy Youngjin SOHN, Mountain View, CA (US)

(73) Assignee: Google Inc., Mountain View, CA (US)

(21) Appl. No.: 13/783,000

(22) Filed: Mar. 1, 2013

(51) Int. Cl. H04L 29/08

(52) U.S. Cl. CPC H04L 67/22
USPC 709/204

(57) ABSTRACT

In one aspect, a method includes receiving an indication of a user request to view content at a social networking site, identifying one or more genres associated with the user, where each genre acts as proxy for a grouping of content that is of interest to the user, determining one or more entities mapped to the one or more genres, identifying a plurality of posts associated with the one or more entities and providing one or more of the plurality of posts for display to the user in response to receiving the indication. Other aspects can be embodied in corresponding systems and apparatus, including computer program products.

### BACKGROUND

Information overload is a common problem in content-based systems. Social networking services are filled with posts and photos from friends, family, and acquaintances with varying levels of relevance to a user. Filtering through the available content to find the most relevant content can be a daunting task for the user and may lead to information fatigue. To solve this problem recommendation systems have been employed to analyze signals in order to determine the most relevant content for a user. Such signals provide relevance indications based on contextual cues such as the current time, user location, tie strength with other members in the community or the content topics being shared in posts. These signals may be helpful in a general social networking setting, but in a domain-specific community the signals can be quite different. For example, a social networking community built around clothing and fashion styles requires a different set of signals for recommending content than a generic social networking service would need. Therefore, domain specific social networking settings present a challenge with regard to identifying what content is most relevant to a user to provide the user with relevant posts.

### SUMMARY

The disclosed subject matter relates to a machine-implemented method including receiving an indication of a user request to view content at a social networking site. The method further including identifying one or more genres associated with the user, where each genre acts as proxy for a grouping of content that is of interest to the user. The method further including determining one or more entities mapped to the one or more genres. The method further including identifying a plurality of posts associated with the one or more entities and providing one or more of the plurality of posts for display to the user in response to receiving the indication. Other aspects can be embodied in corresponding systems and apparatus, including computer program products.

These and other aspects can include one or more of the following features. A genre may define a general preference of the user for a specific type of content. A genre may include a style or aesthetic preferred by the user. The one or more entities may include one or more of product brands, users, or categories.

The method may further include ranking the plurality of items according to one or more ranking criteria and selecting the one or more items according to the ranking. The method may further include receiving a post generated by a user of the social networking service and determining one or more entities associated with the post.

Determining one or more entities associated with the post may include identifying one or more items being included in the post, identifying one or more brands associated with the one or more items, identifying one or more categories associated with the post and identifying one or more users associated with the post. An entity to genre mapping may be manually generated. An entity to genre mapping may be generated according to a grouping of the entity with one or more other entities in one or more posts, where the one or more other entities are associated with the genre.

The method may further include providing the user with one or more genre identifiers, receiving a selection of one or more of the genre identifiers by the user, determining one or more genres according to the selections by the user and associating the one or more genres with the user. The genre identifiers may include one or more items representations corresponding to a genre. The genre identifiers may include visual or textual descriptors of the one or more genres.

The method may further include recommending one or more other genres to the user according to the association of the user with the one or more genres, where the one or more other genres are mapped to at least one or more of the one or more entities.

The disclosed subject matter also relates to a system including one or more processors and a machine-readable medium including instructions stored therein, which when executed by the processors, cause the processors to perform operations including receiving one or more genre subscriptions from a user, each of the one or more genres representing a general grouping of a type of content. The operations further including receiving an indication of a user request to view content at a social networking site. The operations further including determining one or more entities mapped to the one or more genres, the one or more entities including one or more of brands and users. The operations further including identifying a plurality of posts associated with the one or more entities and providing one or more of the plurality of posts for display to the user in response to receiving the indication. Other aspects can be embodied in corresponding systems and apparatus, including computer program products.

These and other aspects can include one or more of the following features. A brand may be mapped to a genre when items relating to the brand represent the content type represented by the genre. A user may be mapped to a genre when posts associated with the user include items, categories or brands associated with the genre. Posts associated with the user may include one or more of posts created by the user or posts to which the user has contributed.

The disclosed subject matter also relates to a machine-readable medium including instructions stored therein, which when executed by a machine, cause the machine to perform operations including receiving an indication of a user request to view content at a social networking site. The operations further including identifying one or more genres associated with the user, where each genre acts as proxy for a grouping of content by the aesthetic or characteristics represented by the content. The operations further including determining one or more entities mapped to the one or more genres, the one or more entities including one or more of brands and users. The operations further including identifying a plurality of posts associated with the one or more entities, where the mapping is determined based on one or more of items and categories extracted from the post and selecting one or more of the plurality of posts for display to the user. Other aspects can be embodied in corresponding systems and apparatus, including computer program products.

These and other aspects can include one or more of the following features. An entity to genre mapping may be manually generated. An entity to genre mapping may be generated according to a grouping of the entity with one or more other entities in one or more posts, where the one or more other entities are associated with the genre.

The disclosed subject matter also relates to a machine-implemented method including receiving a content item including a plurality of items. The method further including determining one or more entities associated with at least one item of the plurality of items. The method further including determining one or more genres associated with the one or more entities for the at least one item, wherein each genre acts as proxy for a grouping of content that is of interest to the user. The method further including identifying one or more entities associated with at least another item one of the plurality of content items. The method further including determining one or more entities associated with the at least another item and associating at least one of the one or more genres with at least one of the one or more entities associated with the at least another item, wherein the association is based on the at least one item and the at least another item in the same content item. Other aspects can be embodied in corresponding systems and apparatus, including computer program products.

These and other aspects can include one or more of the following features. The method may further include receiving an indication of a user request to view content. The method may further include identifying one or more genres associated with the user, the one or more genres including the at least one of the one or more entities. The method may further include determining one or more entities mapped to the one or more genres. The method may further include identifying a plurality of posts associated with the one or more entities and providing one or more of the plurality of posts for display to the user in response to receiving the indication.

These and other features of the invention described throughout the application provide one or more advantages, including but not limited to, providing a user of a social networking service with an easier process for consuming content at the social networking site including a streamlined on-boarding process and a more complete social networking experience tailored according to the preferences and taste of the user.

It is understood that other configurations of the subject technology will become readily apparent from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several implementations of the subject technology are set forth in the following figures.

FIG. 1 illustrates an example client-server network environment, which provides for recommending content based on proxy-based preference indications.

FIG. 2 illustrates a system diagram of an example system for recommending content based on proxy-based preference indications.

FIG. 3 illustrates a flow diagram of an example process for providing content for display to a user of the social networking service according to proxy-based preference indications of the user.

FIG. 4 illustrates an example data flow diagram of the process of providing content for display to a user of the social networking service according to proxy-based preference indications of the user.

FIG. 5 illustrates a flow diagram of an example process for determining a mapping of content to one or more genres.

FIG. 6 illustrates an example data flow diagram of the process for processing posts generated by a user of the social networking service.

FIG. 7 illustrates an example data flow diagram of the process for mapping one or more entities to one of more genres.

FIG. 8 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent that the subject technology is not limited to the specific details set forth herein and may be practiced without these specific details.

The subject disclosure provides a system and method for recommending content in a social networking setting (e.g., a domain-specific and/or taste-based social networking setting) using a proxy (e.g., a domain specific signal) to understand what content would be most relevant to a user. Domain-specific social networking setting refers to those in which the content is directed to a specific set of content or domain. Taste-based social networking services include communities built around user preference for specific content they share and/or wish to consume. The preference, may, in some examples, include an aesthetic style or look (e.g., with respect to fashion or home & design).

In such communities, unlike other social networking services, signals such as the people a user is following and the degree of affinity between the user and those users followed by the user may not provide a useful indicator of the type of content that a user may want to see on the site. A stronger signal for recommending content may be a genre identifier that indicates a general preference of a user (e.g., chosen explicitly by the user or determined based on user activity with respect to content). The genre is used as a proxy for understanding the most relevant pieces of content. As an example, the subject disclosure describes using the notion of styles as a genre indicator for understanding the most relevant pieces of content for a user in a fashion or home decor social networking service. However, it should be understood that similar systems and methods may be implemented in various social networking systems to recommend content that is relevant to a user.

A genre may provide a higher level grouping that can be used to map to content that a user may favor. For example, content providers (e.g., brands, authors, manufacturer, sponsor, etc.) that a person may prefer, types of content (e.g., aesthetics, context, etc.) a person may appreciate, and content creators that can deliver desirable posts for a user to view may be mapped to a specific genre and provided to a user based on the user being associated with that genre. When creating the mapping between the user and a proxy (e.g., genre, style), the definition of the proxy must cover an appropriate scope of content. That is, the proxy must be defined such that it is not a broad definition that could lead to information overload or a narrow definition that would fail to recommend appropriate content for user consumption.

Defining and using these genres as a proxy for understanding the types of content relevant for a user provides a powerful form of recommendation because it enables the recommendation engine to use the genre to map to different entities in a variety of ways. For example, with respect to fashion or home decor settings, example entities that a style can map to are different brands, posts that are categorized with that style or products that may be representative of that style. By creating a mapping between a genre and the different entity types that map to the genre, different types of signals may be generated to create a well performing recommendation engine. The mapping of providers (e.g., brands, authors, manufacturers, publishers, etc.), types of content, and content creators (e.g., users posting content) to a specific genre may be done in a variety of ways. In one example, the mapping may be performed manually based on structured or unstructured data relating the entity. In some examples, the historical activity associated with the entity may be used to map the entity with a specific genre. In some implementations, the mapping may be based on the content of posts at the site (e.g., with respect to what entities are included in a post and which users post such posts).

A mapping of genres to these entities allows the system to recommend posts and products that relate to entities that represent a genre, without requires the user to explicitly follow each entity separately. For example, if brand A is included in genre X and a user indicates a preference for genre X, any product with brand A or any posts that contain items with brand A could be recommended to the user. Similarly, If post B is categorized as representing genre X, post B could be recommended to a user that is interested in genre X. Similarly, if person C tends to create posts that are related to genre X or include items that are brands mapped to genre X, the system could recommend the posts that are created by person C.

Once the mapping is created, recommendations can also happen in the reverse direction where learning about a user preference for entities (e.g., a brand, author, user, product) can be used to recommend genres to the user. If a user then chooses to follow the recommended genre, a larger set of signals (e.g., entities mapped to the recommended genre) are available for recommending content.

The process reduces the need for a user to follow a large set of people, providers, authors, brands, and categories in order to find interesting and relevant content. Instead the user can follow a particular genre that functions as a proxy to all of these entity types and could be changed and/or updated over time (e.g., based on the mapping of various entities to a single genre). Allowing a user to subscribe to a proxy (e.g., genre) for indicating preference in content provides a streamlined process for on-boarding onto a system. A broader genre based proxy allows the user to quickly move through the initial steps of signing up for a service and start navigating the social experience quickly. The processes described herein reduce friction for onboarding onto a new service and allow a relatively complete experience since the user does not have to subscribe to a large number of entities before being provided with an acceptable volume of content. Instead, subscription in one or more genres that are mapped to different entities provide the user with a quick and easy way to receive a volume of content which would allow a complete experience in the social networking environment.

The use of proxies as an indication of preference further allows for dynamic updating of the proxy definition and mapping of new entities as they become available. As the group of content that may fit into a specific genre (e.g., style) may change over time, the user's experience can be automatically updated (e.g., in real-time) due to the dynamic nature of the proxy definitions. The use of the proxy further provides for providing information regarding trends with respect to different genres based on user activity with regard to the content being mapped to a genre (e.g., social activity such as shares, endorsements, comments, posts, subscriptions, post views, purchases as a result of the social activity and content, suggestions, etc.). Such information may be useful to providers (e.g., merchants, businesses, manufacturers) interested in learning about different trends. The information may, for example, be useful in understanding user preferences and provide useful information on what types of content a target market (e.g., users interested in specific trends) respond to most.

Depending on the domain of the content being provided to a user, the manner in which genres are identified may vary. In some implementations, a user may be provided with a list of various genres associated with content at the site (e.g., genres mapped to various content) and may select genres to subscribe to. In other examples, entities representative of a genre may be provided to a user (e.g., visually) and the user may provide preference (e.g., rating or yes/no preference) for each entity, and appropriate genres may be identified for the user based on the user's preference for various entities. For example, with respect to a fashion or home decor setting, what represents a style may be subjective and easier to identify graphically than try to express with the correct vocabulary. People can easily identify what they like by looking at styles without having to know exactly how to express the particulars of that style. Providing the user with visual or textual descriptions of various genres, or identifying genres based on user preference for entities provides a simpler way of identifying the types of content a user is interested in and may not require that the user initially understand all the domain-specific language needed to express the genres they may be interested in.

Users of social networking services may create associations with one another. The phrase “social networking service” as used herein encompasses its plain and ordinary meaning, including, but not limited to, an online service, platform or site that focuses on building and reflecting of social associations among users. These associations may be stored within a social graph at each social networking service (e.g., maintained at remote server(s) 120). Such user associations may be defined on a user-to-user basis, or as a group of users associated through membership within a group.

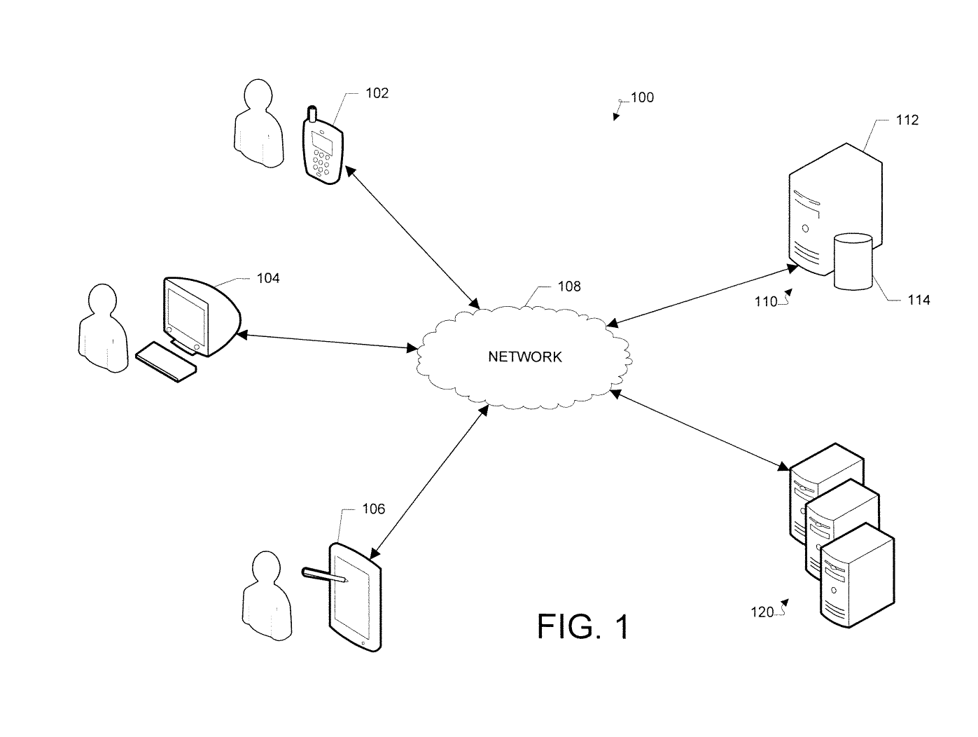

FIG. 1 illustrates an example client-server network environment, which provides for recommending content based on proxy-based preference indications. A network environment 100 includes a number of electronic devices 102, 104, 106 communicably connected to a server 110 and remote servers 120 by a network 108. Network 108 can be a public communication network (e.g., the Internet, cellular data network, dialup modems over a telephone network) or a private communications network (e.g., private LAN, leased lines). Further, network 108 can include, but is not limited to, any one or more of the following network topologies, including a bus network, a star network, a ring network, a mesh network, a star-bus network, a tree or hierarchical network, and the like.

In some example implementations, electronic devices 102, 104, 106 can be computing devices such as laptop or desktop computers, smartphones, PDAs, portable media players, tablet computers, or other appropriate computing devices. In the example of FIG. 1, electronic device 102 is depicted as a smartphone, electronic device 104 is depicted as a desktop computer and electronic device 106 is depicted as a PDA.

In some implementations, server 110 includes a processing device 112 and a data store 114. Processing device 112 executes computer instructions stored in data store 114, for example, to facilitate recommending content based on proxy-based preference indications to users interacting with electronic devices 102, 104, 106. Server 110 may further be in communication with remote servers 120 either through the network 108 or through another network or communication means.

In one example, the system may further comprise one or more other remote servers 120 performing various functionalities and/or storage capabilities described herein with regard to the server 110 either alone or in combination with server 110. Server 110 may further maintain or be in communication with social networking services hosted on one or more remote server 120. The one or more social networking services may provide various services and may enable users to create a profile and associate themselves with other users at a remote social networking service. The server 110 and/or the one or more remote servers 120 may further facilitate the generation and maintenance of a social graph including the user created associations. The social graphs may include, for example, a list of all users of the remote social networking service and their associations with other users of a remote social networking service.

In some example aspects, server 110 and/or one or more remote servers 120 can be a single computing device such as a computer server. In other implementations, server 110 and/or one or more remote servers 120 can represent more than one computing device working together to perform the actions of a server computer (e.g., cloud computing). Server 110 and/or one or more remote servers 120 may be coupled with various remote databases or storage services. While server 110 and the one or more remote servers 120 are displayed as being remote from one another, it should be understood that the functions performed by these servers may be performed within a single server, or across multiple servers.

Communications between the client devices 102, 104, 106, server 110 and/or one or more remote servers 120 may be facilitated through the HTTP communication protocol. Other communication protocols may also be facilitated including for example, XMPP communication, for some or all communications between the client devices 102, 104, 106, server 110 and one or more remote servers 120 (e.g., through network 108).

Users may interact with the system hosted by server 110, and/or one or more social networking services hosted by remote servers 120, through a client application installed at the electronic devices 102, 104, 106. Alternatively, the user may interact with the system and the one or more social networking services through a web based browser application at the electronic devices 102, 104, 106. Communication between client devices 102, 104, 106 and the system, and/or one or more social networking services, may be facilitated through a network (e.g., network 108).

The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

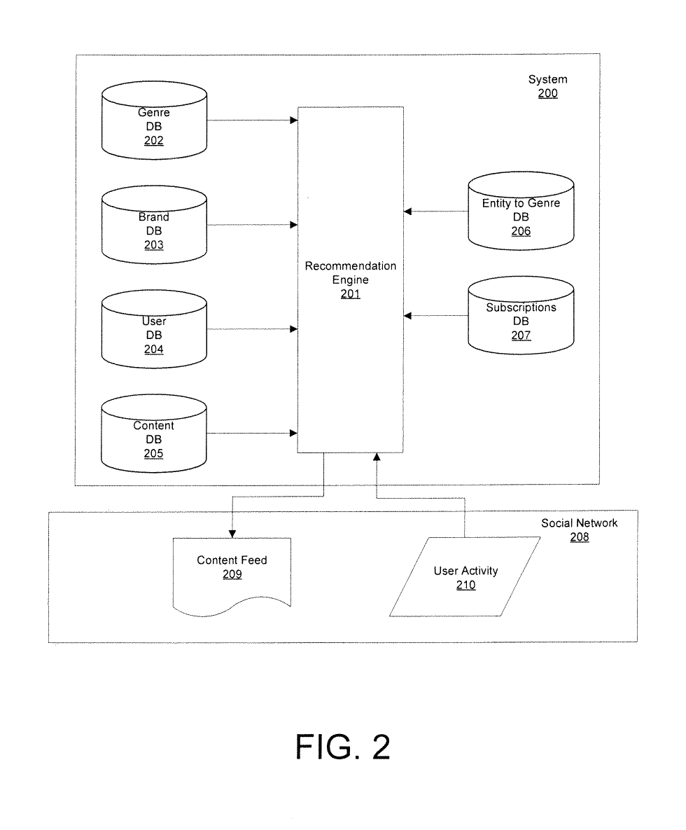

FIG. 2 illustrates a system diagram of an example system 200 for recommending content based on proxy-based preference indications. System 200 may include one or more processors, computers, and/or server computers. In some implementations system 200 may be hosted on server 110. System 200 includes a recommendation engine 201 and data stores 202-207. Recommendation engine 201 is configured to receive information regarding genre selections by a user, to map different entities (e.g., users, brands, posts) to genres, and to recommend content for display to a user.

The data stores 202-207 contain data for facilitating recommendation of content based on proxy-based preference indications. Genre database 202 stores information regarding the different genres that can be subscribed to by a user. In one example, the genre database may further store information associated with one or more genre including genre definitions (e.g., including mappings of other entities to the genre and/or how an entity will be mapped to the genre), and other information regarding genres and their mapping.

Brand database 203 stores information regarding the brands associated with one or more items. “Brands” as used herein refer to an identifier of the source of an item (e.g., products or services) and may include identifiers representing one or more of manufacturers, providers, authors, owners, sponsors, and other entities having control and/or ownership of one or more items. In one example, brands stored within the brand database 203 may include brands associated with content generated by one or more users of the social networking service or otherwise associated with the users. In some examples, a listing of brands may be generated and stored in the brand database 203 and may be updated (e.g., manually by adding additional brands and/or based on user generated content or user subscriptions to brands).

User database 204 stores information regarding users of the social networking service, including, for example, one or more of types of content posted by the user, user activity with respect to content at the social networking site, mapping of user to one or more genres (e.g., when the user prefers styles and/or posts content relating to various genres). Content database 205 stores content generated by one or more users at the social networking site. The content may include representations and/or identifiers for one or more items (e.g., products, people, places, etc.) and the one or more items may be mapped to one or more genres. In one example, the content further includes an identifier of the user creating the content and/or contributions to the content (e.g., suggestions, reviews, ratings, etc.). Such information may be stored along with the content at the content database, and/or may be stored in a separate database.

An entity to genre database 206 may store indices of mapping of one or more entities to one or more genres. In one example, one or more tables or other mapping indicators may be stored within the entity to genre database. In one example, the mapping may include one or more of mapping of one or more brands, items, users, posts and/or other similar entities to one or more genres. In one example, the entity to genre database may include the content (e.g., indexed by item and/or category) for mapping to one or more entities and/or genres. Subscriptions database 207 may store one or more user subscriptions for each one or more users of the social networking service. In one example, a user may subscribe to various users, brands, or other entities. In one example, the subscription database 207 may further store genre subscriptions for a user. In one example, the subscriptions may be stored in each database (e.g., 202-206) for each different entity or may be accessible by each entity from the subscriptions database 207 and/or genre database 202.

System 200 may include one or more computing devices, data stores and may be hosted on one or more servers (e.g., local server 110 and/or remote servers 120) and may be in communication with one or more local and remote databases.

System 200 may be communicationally coupled (e.g., via network 108) to one or more social networking services 208 (e.g., hosted at one or more remote servers 120), and/or one or more client devices (e.g., client devices 102, 104 and 106 including, for example, a personal computer, server, smart phone, PDA, tablet, or the like). For example, the various computers and/or storages may be connected to and/or communicate with each other via the Internet, or a private LAN/WAN. In some aspects, the various connections may be made over a wired or wireless connection.

System 200, for example, via the recommendation engine, may be configured to communicate with a content feed 209 of a social networking service 208. Content feed 209 may provide content to one or more users of the social networking servicer 208, for example, according to the methods described herein. Social networking service 208 may further facilitate user activity at the social networking service and may collect data regarding the user activity, via a user activity element 210. User activity element 210 may comprise one or more processes, modules, services, applications, databases, or other computing devices and applications configured to facilitate and/or analyze user activity at the social networking service 208. In one example, user activity at the social networking service 208 may include user subscriptions (e.g., to one or more entities or genres), and user interactions with one or more other users or content posted to the social networking service 108. Social activity, as used herein, may include comments, endorsements, suggestions, shares and other activities performed by one or more users of the social networking service. In one example, the user activity element provides information regarding user activity at the social networking service 208 to the system 200, for example, via the recommendation engine 201, for analysis and/or for facilitating recommending content based on proxy-based preference indications.

The functionality of system 200 and one or more social networking services 208 may be implemented on the same physical server or distributed among a plurality of servers (e.g., servers 110 and/or 120). Similarly, the functionality of data stores 202-207 may be implemented in the same storage device or computer, or distributed across a plurality of storage devices or computers. The storages may take any form such as relational databases, object-oriented databases, file structures, text-based records, or other forms of data repositories. While each storage is illustrated as a single storage, it is understood that system 200 can control access to and coordinate retrieval of information from a cloud computing environment including multiple databases and database servers. The data stores are referred to herein as databases for illustration purposes, and are not limited to databases. Various storage data structures may be used to store various information contained within and/or used by the system 200 and/or social networking service 208.

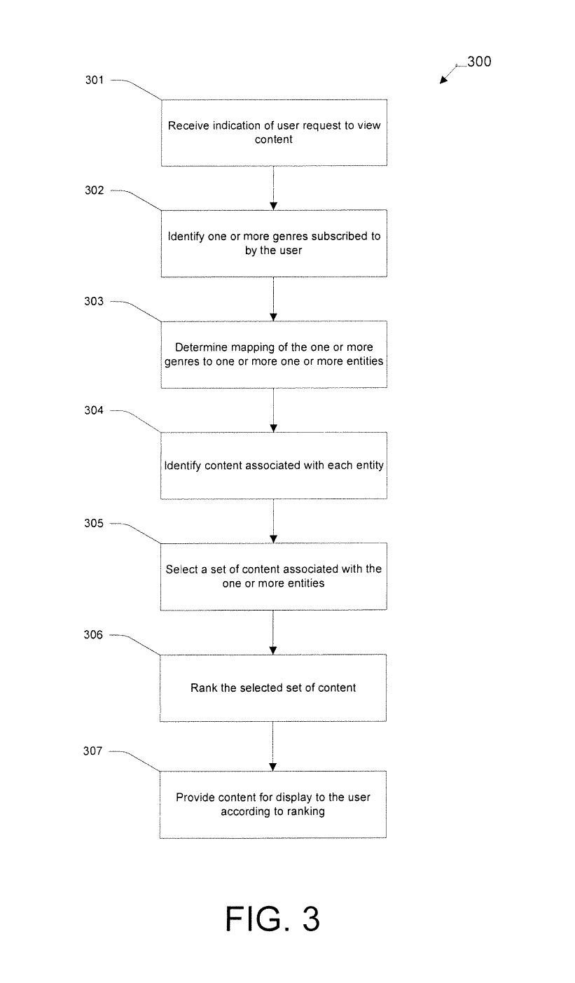

FIG. 3 illustrates a flow diagram of an example process 300 for providing content for display to a user of the social networking service according to proxy-based preference indications of the user. In step 301, an indication of user request to view content is received. In one example, the indication may be received in response to the user signing up for the service, logging into the system, refreshing the user content feed, subscribing to new content or entities. In some implementations, the indication may further be received when the social networking service determines that the content feed being provided for display to the user must be refreshed, regenerated or otherwise modified with new or modified content.

In step 302, one or more genres subscribed to by the user are identified. In one example, the subscriptions of the user may be stored in association with the user in one or more data stores (e.g., style database 202, user database 204 and/or subscriptions database 207). In some implementations, the user may, at any time select one or genres that are of interest to the user. In some examples, the system may identify one or more genres of interest to the user based on user activity (e.g., user subscriptions, social activity, selections of one or more items indicative of user preference, etc.).

In step 303, for each of the one or more genres identified in step 302, one or more entities mapped to the genre may be identified. The mapping of entities to one or more genres may be performed according to various methods. In one or more implementations, the mapping of one or more entities to a genre may be performed manually, by the system, administrator and/or one or more users of the social networking service. In some implementations, the mapping of one or more entities to a genre may be performed according to the activities and/or content associated with the entity at the social networking service or otherwise available for analysis.

For example, in some implementations, the mapping of an entity to a genre may be performed according to the content in which the entity or an item associated with the entity appears in or is otherwise associated with. In one example, when the system receives content, the system may determine that one or more items or entities are associated with the content (e.g., the content is created by an entity, owned by one or more entities, includes entity identifiers or includes representations of one or more items associated with one or more entities). In one example, the entities are mapped to one or more genres according to mapping information regarding other entities in the same post (or associated with items in the same post) or the category of the post. That is, in some implementations, the genres associated with a post may be determined by identifying one or more items associated with entities and/or entities within the post mapped to one or more genres. In some example, additional items or entities within the post are identified and also mapped to the genre (e.g., according to their grouping with other items and entities having a preexisting mapping to the genre). The process for mapping entities to one or more genres is described in more detail below.

Dynamic and/or real-time generation and updating of genre definitions is provided as the proxy definitions are based on mapping of entities to a genre, and are updated (e.g., dynamically and/or in real-time) as additional content is provided that provides further information for expanding and/or modifying the genre definitions (e.g., by creating updated entity to genre mappings). Dynamic updating of the proxy definition and mapping of new entities as they become available thus provides for real-time, dynamic proxy definitions, as new genres are generated and/or existing genres are updated with new mappings. As the group of content that may fit into a specific genre (e.g., style) may change over time, the user's experience can be automatically updated (e.g., in real-time) due to the dynamic nature of the proxy definitions.

In step 304, one or more content associated with the one or more entities determined in step 303 are identified. As described above, in one example, content at the social networking site may comprise posts by one or more users of the social networking site. The term “post”, as used herein, may include any content shared by one or more users of the social networking site and/or generated for consumption of one or more users of the social networking site including user generated content, multi-media content, advertisements, sponsored content, and other similar content. In one example, a post may include one or more identifiers and representations of one or more items and/or entities. In one example, an item or entity may comprise one or more of products, services, users, businesses, and may be associated with users, brands, or other similar items or entities. In some example, items and/or entities within the post may be mapped to a genre and/or may be associated with another entity mapped to a genre. In one example, the content may further be associated with one or more categories (e.g., defining the category to which the content or items or entities represented within the content relate). The content may be stored in one or more storage devices (e.g., content database 205). Mapping information regarding the mapping of the post with entities and/or genres may further be accessible through one or more storage devices (e.g., brand database 203, user database 204, content database 205 and/or entity to genre database 206). In one example, posts may be identified as being mapped to one or more entities or may be directly mapped to one or more genres. In some implementations, the content may be indexed according to the entities, items and/or categories associated with the content and stored for mapping to one or more entities and/or genres.

In step 306 the identified content may be ranked according to one or more ranking criteria. In one example, the content may be ranked according to one or more of global ranking criteria and/or user-specific ranking criteria. Global ranking criteria may employ signals such as trends, topicality, popularity, and/or other similar indications of overall popularity of posts to assign a score or rank to the content. User-specific ranking criteria may include the level of social activity associated with a post by one or more users (e.g., the user, users the user is following, or those following the user, contacts of the user, etc.). The one or more ranking criteria may be used to assign a score to each post. The score for each post may then be used to rank the content. In step 307, one or more of the content is provided for display to the user (e.g., within the content feed 209 of social networking service 208). In some implementations, the one or more content is selected and/or provided for display according to the ranking.

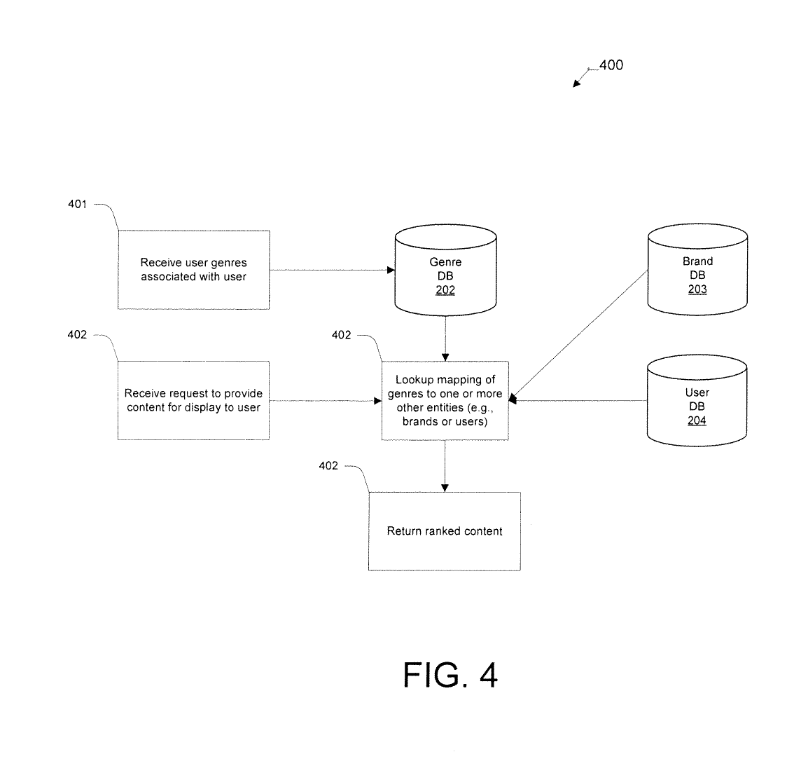

FIG. 4 illustrates an example data flow diagram 400 of the process of providing content for display to a user of the social networking service according to proxy-based preference indications of the user. In block 401, one or more proxy-based user preferences are received. The proxy-based user preferences may include genres selected by the user or identified according to user activity and/or preferences. The one or more genres may be stored at the genre database 202. In one example, the genre database may include a listing of all genres mapped to one or more entities at the database. The genre database may further include a listing of users associated with each genre. In another example, the subscriptions database 207 may also be used to store information regarding the user subscribing to the one or more genres.

In blocked 402, an indication of a request by a user for content for display within a content feed (e.g., content feed 209) is received. In block 403 the system (e.g., the recommendation engine 201) looks up mapping of genres associated with the user (e.g., stored at the genre database 202 and/or the subscriptions database 207) to one or more other entities such as brands or users. In one example, a listing of brands and users may be stored in one or more data stores (e.g., brand database 203 and user database 204). The mapping of one or more entities to the genre may be stored at one or more data stores. The mappings are used to identity content relating to the genres as described above with respect to FIG. 3. In block 404 the ranked content is retuned for display to the user (e.g., at the social networking service 208). As described above, the content provided to the user is selected based on the association of one or more entities, items or categories with the post, and the mapping of the entities, items and/or categories with one or more genres.

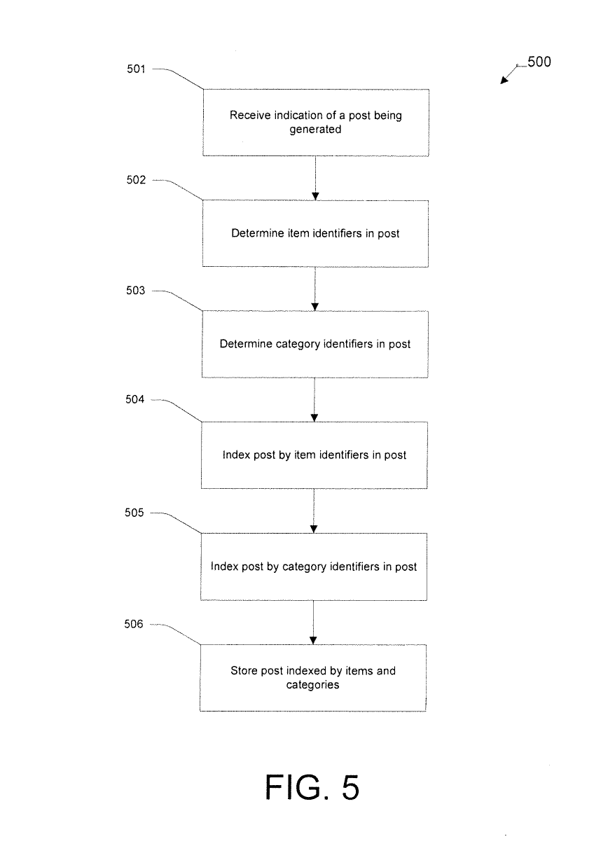

FIG. 5 illustrates a flow diagram of an example process 500 for determining a mapping of content to one or more genres. In step 501, an indication of a post being generated by a user of the social networking service is received. In step 502, one or more item identifiers (e.g., identifiers or representations) within the post are determined. Items may include products included within a post (e.g., visually, through a tag, or by an explicit identifier of the product being included in the post). In step 503, the item is indexed by the item identifiers.

In step 504, one or more categories associated with the post are determined. In one example, when a post is being generated the post may be associated with one or more categories describing the type of items and/or entities that the post relates to (e.g., explicitly stated by the user, or determined by the system based on the categories associated with items identified in step 502). In step 505, the item is indexed by the determined categories.

In step 506, the item is stored indexed by the items and/or categories. In one example, the determined item identifiers and category identifiers are used to generate mappings between the post, and/or one or more entities associated with the post (e.g., the user associated with the post, or following the post, the categories associated with the post, the brands associated with the post) and one or more genres according to genre definitions. The information may be used to generate and/or update mappings of one or more entities to genres. In one example, the information for each post is further generated showing the association of the post with the extracted one or more items and/or categories for later selection of the item.

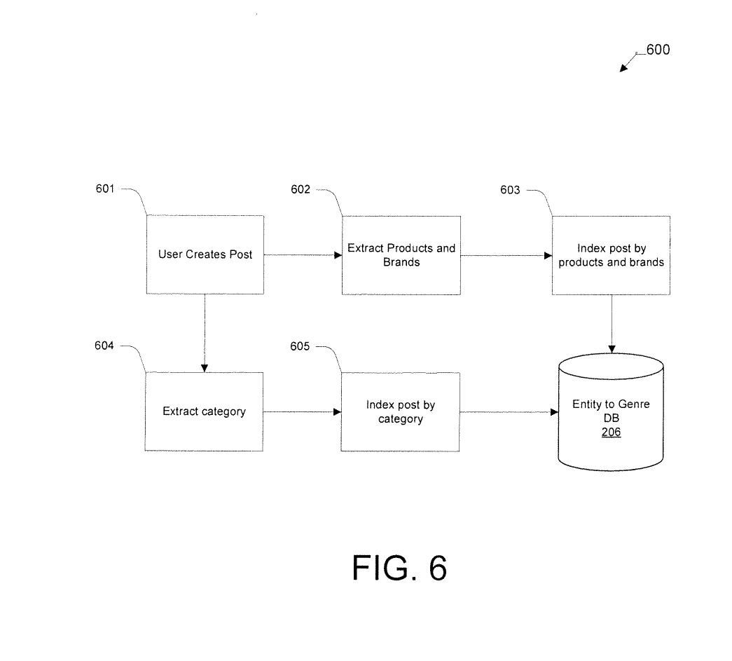

FIG. 6 illustrates an example data flow diagram 600 of the process for processing posts generated by a user of the social networking service. In block 601, an indication of a post being generated by a user of the social networking service is received. In block 602, one or more item identifiers (e.g., identifiers or representations) within the post are extracted. Items may include products included within a post (e.g., visually, through a tag, or by an explicit identifier of the product being included in the post). In block 603, the item is indexed according to the item identifiers in the post.

In block 604, one or more categories associated with the post are extracted from the post. In one example, when a post is being generated the post may be associated with one or more categories describing the type of items and/or entities that the post relates to (e.g., explicitly stated by the user, or determined by the system based on the items extracted in block 602). In block 604, the item is indexed by the category identifiers in the post. The post indexed according to the extracted one or more categories is then stored in the entity to genre database 206. In some example, the extracted items and/or categories are used to map the post to one or more entities and determine genres to which the content relates.

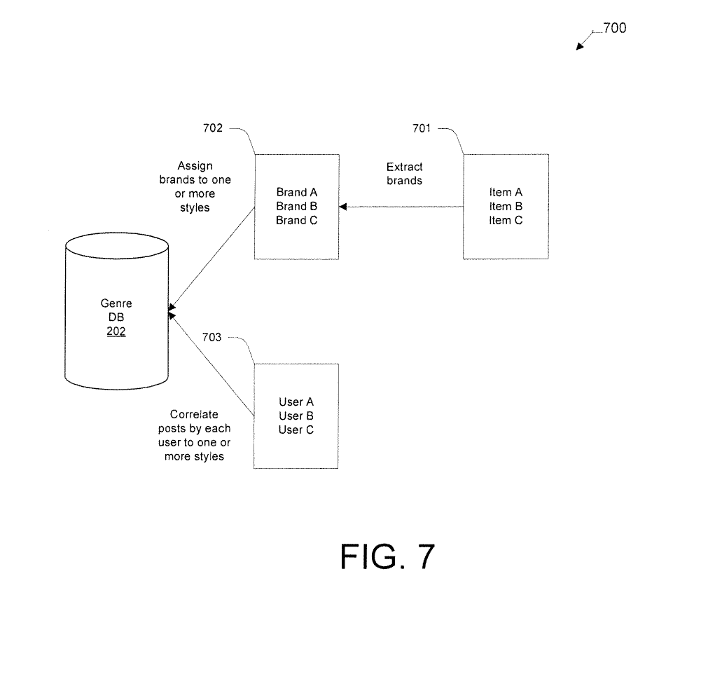

FIG. 7 illustrates an example data flow diagram 700 of the process for mapping one or more entities to one of more genres. In block 701 one or more items (e.g., products) are received. The brands associated with the one or more items are extracted and provided to block 702. In block 702, each brand is associated with a genre according to the genre definition or other mapping criteria. As described above, mappings of brands to genres may be performed by explicit association of a brand with a style, or based on activity with relation to one or more items associated with the brand. For example, in some implementations, items included in posts and associated with the brand are used to determine whether a brand is indicative of a genre. Other activity (e.g., social activity) relating to a brand, items or posts may also indicate whether a brand relates to a certain genre and may be used to map the brand to the genre.

In block 703 one or more users are mapped to a genre according to the posts generated by each user, as well as other indicators such as contribution of the user to posts, subscriptions of the user to brands, other users, etc. In one example, when posts provided by a user are mapped to a genre (e.g., include items or categories associated with the genre) the user may be mapped to the genre. The mapping information regarding the one or more users and/or brands in stored, for example, in the genre database 202). As described above, the mapping performed in blocks 702 and 703 may be based on various mapping criteria and genre definitions (e.g., including explicit associations and/or inherent associations according to the grouping of content within a post).

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

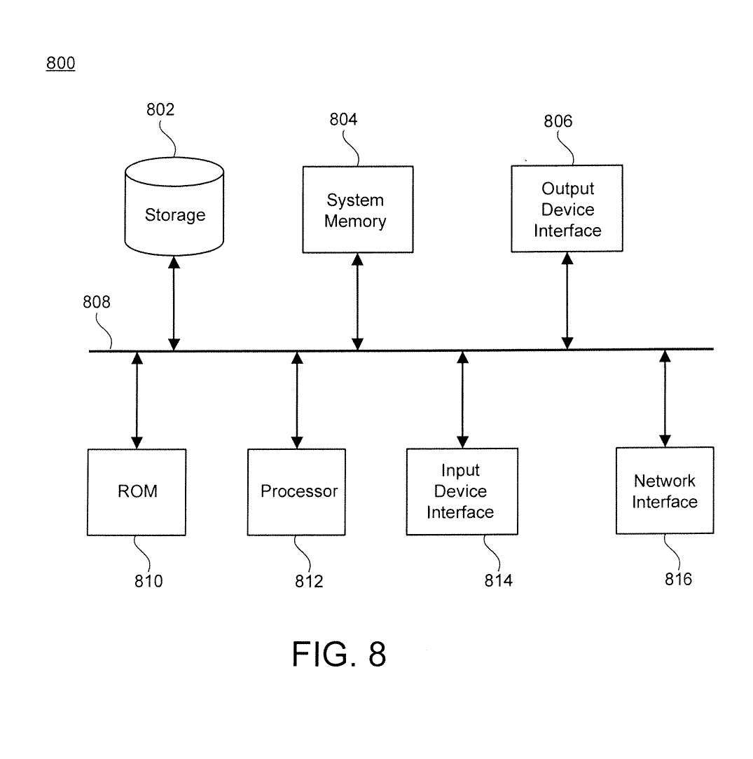

FIG. 8 conceptually illustrates an electronic system with which some implementations of the subject technology are implemented. Electronic system 800 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 800 includes a bus 808, processing unit(s) 812, a system memory 804, a read-only memory (ROM) 810, a permanent storage device 802, an input device interface 814, an output device interface 806, and a network interface 816.

Bus 808 collectively represents all system, peripheral, and chipset buses that communicatively connect the numerous internal devices of electronic system 800. For instance, bus 808 communicatively connects processing unit(s) 812 with ROM 810, system memory 804, and permanent storage device 802.

From these various memory units, processing unit(s) 812 retrieves instructions to execute and data to process in order to execute the processes of the subject disclosure. The processing unit(s) can be a single processor or a multi-core processor in different implementations.

ROM 810 stores static data and instructions that are needed by processing unit(s) 812 and other modules of the electronic system. Permanent storage device 802, on the other hand, is a read-and-write memory device. This device is a non-volatile memory unit that stores instructions and data even when electronic system 800 is off. Some implementations of the subject disclosure use a mass-storage device (such as a magnetic or optical disk and its corresponding disk drive) as permanent storage device 802.

Other implementations use a removable storage device (such as a floppy disk, flash drive, and its corresponding disk drive) as permanent storage device 802. Like permanent storage device 802, system memory 804 is a read-and-write memory device. However, unlike storage device 802, system memory 804 is a volatile read-and-write memory, such a random access memory. System memory 804 stores some of the instructions and data that the processor needs at runtime. In some implementations, the processes of the subject disclosure are stored in system memory 804, permanent storage device 802, and/or ROM 810. For example, the various memory units include instructions for recommending content for display to a user at a social networking service based on proxy-based preference indications of the user. From these various memory units, processing unit(s) 812 retrieves instructions to execute and data to process in order to execute the processes of some implementations.

Bus 808 also connects to input and output device interfaces 814 and 806. Input device interface 814 enables the user to communicate information and select commands to the electronic system. Input devices used with input device interface 814 include, for example, alphanumeric keyboards and pointing devices (also called “cursor control devices”). Output device interfaces 806 enables, for example, the display of images generated by the electronic system 800. Output devices used with output device interface 806 include, for example, printers and display devices, such as cathode ray tubes (CRT) or liquid crystal displays (LCD). Some implementations include devices such as a touchscreen that functions as both input and output devices.

Finally, as shown in FIG. 8, bus 808 also couples electronic system 800 to a network (not shown) through a network interface 816. In this manner, the computer can be a part of a network of computers (such as a local area network (“LAN”), a wide area network (“WAN”), or an Intranet, or a network of networks, such as the Internet. Any or all components of electronic system 800 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that some illustrated steps may not be performed. Some of the steps may be performed simultaneously. For example, in certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

What is claimed is:

1. A machine-implemented method, comprising:
receiving an indication of a user request to view content;
identifying one or more genres associated with the user, wherein each genre acts as proxy for a grouping of content that is of interest to the user;
determining one or more entities mapped to the one or more genres;
identifying a plurality of posts associated with the one or more entities; and
providing one or more of the plurality of posts for display to the user in response to receiving the indication.

2. The method of claim 1, wherein a genre defines a general preference of the user for a specific type of content.

3. The method of claim 1, wherein a genre comprises a style or aesthetic preferred by the user.

4. The method of claim 1, wherein the one or more entities comprise one or more of product brands, users, or categories.

5. The method of claim 1, further comprising:
ranking the plurality of items according to one or more ranking criteria; and
selecting the one or more items according to the ranking.

6. The method of claim 1, further comprising:
receiving a post generated by a user of the social networking service; and
determining one or more entities associated with the post.

7. The method of claim 6, the determining one or more entities associated with the post comprising:
identifying one or more items being included in the post;
identifying one or more brands associated with the one or more items;
identifying one or more categories associated with the post; and
identifying one or more users associated with the post.

8. The method of claim 1, wherein an entity to genre mapping is manually generated.

9. The method of claim 1, wherein an entity to genre mapping is generated according to a grouping of the entity with one or more other entities in one or more posts, wherein the one or more other entities are associated with the genre.

10. The method of claim 1, further comprising:
providing the user with one or more genre identifiers;
receiving a selection of one or more of the genre identifiers by the user;
determining one or more genres according to the selections by the user; and
associating the one or more genres with the user.

11. The method of claim 10, wherein the genre identifiers comprise one or more items representations corresponding to a genre.

12. The method of claim 10, wherein the genre identifiers comprise visual or textual descriptors of the one or more genres.

13. The method of claim 1, further comprising:
recommending one or more other genres to the user according to the association of the user with the one or more genres, wherein the one or more other genres are mapped to at least one or more of the one or more entities.

14. A system comprising:
one or more processors; and
a machine-readable medium comprising instructions stored therein, which when executed by the processors, cause the processors to perform operations comprising:
receiving one or more genre subscriptions from a user, each of the one or more genres representing a general grouping of a type of content;
receiving an indication of a user request to view content at a social networking site;
determining one or more entities mapped to the one or more genres, the one or more entities comprising one or more of brands and users;
identifying a plurality of posts associated with the one or more entities; and
providing one or more of the plurality of posts for display to the user in response to receiving the indication.

15. The system of claim 14, wherein a brand is mapped to a genre when items relating to the brand represent the content type represented by the genre.

16. The system of claim 14, wherein a user is mapped to a genre when posts associated with the user include items, categories or brands associated with the genre.

17. The system of claim 16, wherein the posts associated with the user comprise one or more of posts created by the user or posts to which the user has contributed.

18. A machine-readable medium comprising instructions stored therein, which when executed by a machine, cause the machine to perform operations comprising:
receiving an indication of a user request to view content at a social networking site;
identifying one or more genres associated with the user, wherein each genre acts as proxy for a grouping of content by the aesthetic or characteristics represented by the content;
determining one or more entities mapped to the one or more genres, the one or more entities including one or more of brands and users;
identifying a plurality of posts associated with the one or more entities, wherein the mapping is determined based on one or more of items and categories extracted from the post; and
selecting one or more of the plurality of posts for display to the user.

19. The machine-readable medium of claim 18, wherein an entity to genre mapping is manually generated.

20. The machine-readable medium of claim 18, wherein an entity to genre mapping is generated according to a grouping of the entity with one or more other entities in one or more posts, wherein the one or more other entities are associated with the genre.

21. A computer-implemented method comprising:
receiving a content item including a plurality of items;
determining one or more entities associated with at least one item of the plurality of items;
determining one or more genres associated with the one or more entities for the at least one item, wherein each genre acts as proxy for a grouping of content that is of interest to the user;
identifying one or more entities associated with at least another item one of the plurality of content items;
determining one or more entities associated with the at least another item; and
associating at least one of the one or more genres with at least one of the one or more entities associated with the at least another item, wherein the association is based on the at least one item and the at least another item in the same content item.

22. The method of claim 21, further comprising:
receiving an indication of a user request to view content;
identifying one or more genres associated with the user, the one or more genres including the at least one of the one or more entities;
determining one or more entities mapped to the one or more genres;
identifying a plurality of posts associated with the one or more entities; and
providing one or more of the plurality of posts for display to the user in response to receiving the indication.
